(19) United States
(12) Patent Application Publication
(10) Pub. No.: US 2003/0129982 A1
(43) Pub. Date: Jul. 10, 2003

(54) Soft handoff in a wireless communication system

(76) Inventor: Patrick Perini, Broomfield, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/039,142

(22) Filed: Jan. 4, 2002

(51) Int. Cl. H04Q 7/20

(52) U.S. Cl. 455/442; 455/436; 455/438; 370/331; 370/332

(57) ABSTRACT

A method and system for performing a multi-channel soft handoff of a communication service in a wireless communication system between two different frequency channels. In one aspect of the multi-channel soft handoff, the handoff could be an inter-cell (cell to cell) handoff between respective controlling base stations. In another aspect of the multi-channel soft handoff, the handoff could be an intra-cell (within the same cell) handoff between different frequency channels supported by the controlling base station. In yet another aspect of the multi-channel soft handoff, the handoff could be an inter-cell (cell to cell) handoff between respective controlling base stations over the same frequency channel followed by an intra-cell handoff at the new base station between different frequency channels.

### FIELD OF THE INVENTION

The invention is related to the field of wireless communications, and in particular, to a method and system for performing a soft handoff in a wireless communication network between at least two different frequency channels.

### BACKGROUND OF THE INVENTION

Code Division Multiple Access (“CDMA”) is a digital technology commonly used in wireless communication systems. CDMA systems use “spread spectrum” technology, wherein base stations communicate with mobile units over a common bandwidth or frequency channel using orthogonal or quasi-orthogonal sequences to define individual traffic channels within the common frequency channel. A CDMA frequency channel is nominally 1.23 MHz wide, and includes forward traffic channels to carry traffic from the base station to the mobile units and reverse traffic channels to carry traffic from the mobile units to the base station. The base stations can typically support one or more of these frequency channels, as a matter of design choice, with each frequency channel having respective forward and reverse traffic channels. Each traffic channel, however, requires power to transmit its bit stream, which also generates noise for other traffic channels in the same frequency band. Thus, the power level of any bit stream has a direct impact on the system's capacity and the system is said to be interference limited.

In wireless communication systems such as a CDMA system, a base station and mobile unit located within the base stations cell area establish a wireless communication link using a call origination protocol. During a call, the mobile unit is free to travel between multiple cells within the wireless system. As the mobile unit travels between cells, movement of the mobile unit is detected, and the call is handed off from one base station to another using a handoff protocol.

Handoffs are generally classified into one of two types, “soft” and “hard” handoffs. Hard handoffs are typically used in systems, such as analog systems wherein the frequency channels utilized by the individual base stations differ. Soft handoffs, on the other hand, are typically used in systems, such as a CDMA system where the same frequency channel is utilized during the entire call regardless of the host base station.

During a hard handoff, known in the art as “break before make” handoff, the mobile unit terminates communication with the current base station prior to establishing communication with a new base station. The “break before make” handoff is necessary because the available frequency channels in adjoining cells differ, and thus when a mobile unit moves from one cell to another cell, the old frequency channel must be terminated so that a new frequency channel can be tuned.

During a soft handoff, known in the art as “make before break” handoff, the mobile unit establishes communication with one or more new base stations prior to terminating communication with the current base station. In this regard, soft handoffs are considered preferable as they result in fewer “dead zones” and the reduction of interruptions in service or dropped calls. The soft handoff is made possible because in a CDMA system, all base stations use the same frequency channel for each mobile unit, with individual device communications being identified by a spreading code that is unique to the device, rather than by a frequency or time slot.

The use of the same frequency channel, however, results in a major disadvantage when the capacity of a base station is taxed, requiring the addition of one or more new frequency channels. In this case, the new channel(s) must be added to all base stations in the surrounding cells as well as the taxed base station if the soft handoff procedure is to be used. This is true regardless of whether or not the other base station capacities are taxed. Unfortunately, this often results in the addition of equipment and resources to base stations whose capacity is not taxed, simply because an adjacent base station's capacity is taxed.

### SUMMARY OF THE INVENTION

The present invention advances the art by providing a method and system for soft handoff in a wireless communication system between two different frequency channels, referred to herein as a multi-channel soft handoff. In the context of the present invention, the first second, third, etc. connotations used to reference the base stations and frequency channels are for the purpose of differentiating between different base stations and frequency channels and are not used to indicate a method or processing sequence.

A first advantage of the present invention is that it does not require the addition of a new frequency channel to all cell sites to add capacity to the wireless communication system. A second advantage of the present invention is that efficiency and load balancing in the communication system is improved by permitting a mobile unit to use one of multiple available frequency channels. A third advantage of the present invention is that interference between frequency channels during a handoff is reduced.

These and other advantages are provided by a first aspect of the present invention, which includes a wireless communication system configured to perform an inter-cell (cell to cell) multi-channel soft handoff between two different frequency channels. The wireless communication system comprises at least one mobile unit and first and second base stations controlling communications in first and second wireless cells respectively. The mobile unit includes a first receiver to communicate over a first frequency channel and a second receiver to communicate over a second frequency channel. The first base station is configured to establish communication with the mobile unit over one of the first and second frequency channels. During the present inter-cell soft handoff, the second base station is configured to establish communication with the mobile unit over the other one of the first and second frequency channels so that the mobile unit is simultaneously exchanging substantially equivalent communications for a call with the first and second base stations over the first and second frequency channel. Responsive to establishing the simultaneous communications, the mobile unit is further configured to terminate the communication with the first base station while maintaining the communication with the second base station to complete the multi-channel inter-cell soft handoff.

Various refinements exist of the features noted in relation to the subject first aspect of the present invention. Further features may also be incorporated in the subject first aspect of the present invention as well. These refinements and additional features will be apparent from the following description and may exist individually or in any combination.

According to a second aspect of the present invention, a wireless communication system configured to perform an intra-cell (within the same cell) multi-channel soft handoff is provided. The wireless communication system comprises at least one mobile unit and at least one base station controlling communication service in a cell. The mobile unit includes the first receiver to communicate over the first frequency channel and the second receiver to communicate over the second frequency channel. The base station is configured to establish communication with the mobile unit over one of the first and second frequency channels. During the multi-channel intra-cell soft handoff, the base station is configured to also establish communication with the mobile unit over the other one of the first and second frequency channels so that the mobile unit is simultaneously exchanging substantially equivalent communications for a call with the base station over the first and second frequency channels. Responsive to establishing the simultaneous communications, the mobile unit is configured to terminate the communication with the base station over the first frequency channel while maintaining the communication over the second frequency channel to complete the multi-channel intra-cell soft handoff.

Various refinements exist of the features noted in relation to the subject second aspect of the present invention. Further features may also be incorporated in the subject second aspect of the present invention as well. These refinements and additional features will be apparent from the following description and may exist individually or in any combination.

According to a third aspect of the present invention, a wireless communication system configured to perform a multi-channel inter-cell and intra-cell soft handoff is provided. The communication system comprises at least one mobile unit and a first and second base station controlling communications in first and second wireless cells respectively is provided. The mobile unit includes the first receiver to communicate over the first frequency channel and the second receiver to communicate over the second frequency channel. The first base station is configured to establish communication with the mobile unit over the first frequency channel. During the multi-channel inter/intra-cell soft handoff, the second base station is configured to establish communication with the mobile unit over the first frequency channel so that the mobile unit is simultaneously exchanging substantially equivalent communications for a call with the base stations over the first frequency channel. Responsive to establishing the simultaneous communications, the mobile unit is configured to terminate the communication with the first base station while maintaining the communication with the second base station over the first frequency channel. Responsive to termination of the communication with the first base station, the second base station is further configured to establish communication with the mobile unit over the second frequency channel so that the mobile unit is simultaneously exchanging substantially equivalent communications for the call with the second base station over the first and second frequency channels. Responsive to establishing the simultaneous communications with the second base station, the mobile unit is configured to terminate the communication with the second base station over the first frequency channel while maintaining the communication with the second base station over the second frequency channel to complete the multi-channel inter/intra-cell soft handoff.

Various refinements exist of the features noted in relation to the subject third aspect of the present invention. Further features may also be incorporated in the subject third aspect of the present invention as well. These refinements and additional features will be apparent from the following description and may exist individually or in any combination.

According to a fourth aspect of the present invention, a method for performing a multi-channel inter-cell soft handoff between a mobile unit and first and second base stations is provided. The method includes the step of establishing communication between the mobile unit and the first base station over the first frequency channel. During the multi-channel inter-cell soft handoff, the method includes establishing communication between the mobile unit and the second base station over the second frequency channel so that the mobile unit is simultaneously exchanging substantially equivalent communications with the first base station over the first frequency channel and the second base station over the second frequency channel. The method further includes terminating the communication with the first base station to complete the multi-channel inter-cell soft handoff.

Various refinements exist of the features noted in relation to the subject fourth aspect of the present invention. Further features may also be incorporated in the subject fourth aspect of the present invention as well. These refinements and additional features will be apparent from the following description and may exist individually or in any combination.

According to a fifth aspect of the present invention, a method for performing a multi-channel intra-cell soft handoff between a mobile unit and base station is provided. The method includes the step of establishing communication between the mobile unit and the first base station over the first frequency channel. During the present intra-cell soft handoff, the method includes establishing communication between the mobile unit and the base station over the second frequency channel so that the mobile unit is simultaneously exchanging substantially equivalent communications for a call with the base station over the first frequency channel and the second frequency channel. The method further includes terminating the communication with the base station over the first frequency channel to complete the multi-channel intra-cell soft handoff.

Various refinements exist of the features noted in relation to the subject fifth aspect of the present invention. Further features may also be incorporated in the subject fifth aspect of the present invention as well. These refinements and additional features will be apparent from the following description and may exist individually or in any combination.

According to a sixth aspect of the present invention, a method for performing a multi-channel inter/intra-cell soft handoff between a mobile unit and first and second base stations is provided. The method includes the step of establishing communication between the mobile unit and the first base station over the first frequency channel. During the inter/intra-cell soft handoff, the method includes establishing communication between the mobile unit and the second base station over the first frequency channel so that the mobile unit is simultaneously exchanging substantially equivalent communications for a call with the first base station and the second base station over the first frequency channel. The method further includes terminating the communication with the first base station and establishing communication between the mobile unit and the second base station over the second frequency channel so that the mobile unit is simultaneously exchanging substantially equivalent communications for the call with the second base station over the first and second frequency channels. The method further includes terminating the communication with the second base station over the first frequency channel to complete the multi-channel inter/intra-cell soft handoff.

Various refinements exist of the features noted in relation to the subject sixth aspect of the present invention. Further features may also be incorporated in the subject sixth aspect of the present invention as well. These refinements and additional features will be apparent from the following description and may exist individually or in any combination.

### BRIEF DESCRIPTION OF THE DRAWINGS

FIG. 1 illustrates a wireless communication system;

FIG. 2 illustrates an example of a mobile unit according to the present invention;

FIG. 3 is a logical diagram illustrating an example of a multi-channel inter-cell soft handoff according to the present invention;

FIG. 4 is a logical diagram illustrating an example of a multi-channel intra-cell soft handoff according to the present invention;

FIG. 5 is a logical diagram illustrating an example of a multi-channel inter/intra-cell soft handoff according to the present invention; and

FIG. 6 is a logical diagram illustrating an example of a multi-channel three-way inter-cell soft handoff according to the present invention.

### DETAILED DESCRIPTION

Reference will now be made to the accompanying drawings, which at least assist in illustrating the various pertinent features of the present invention.

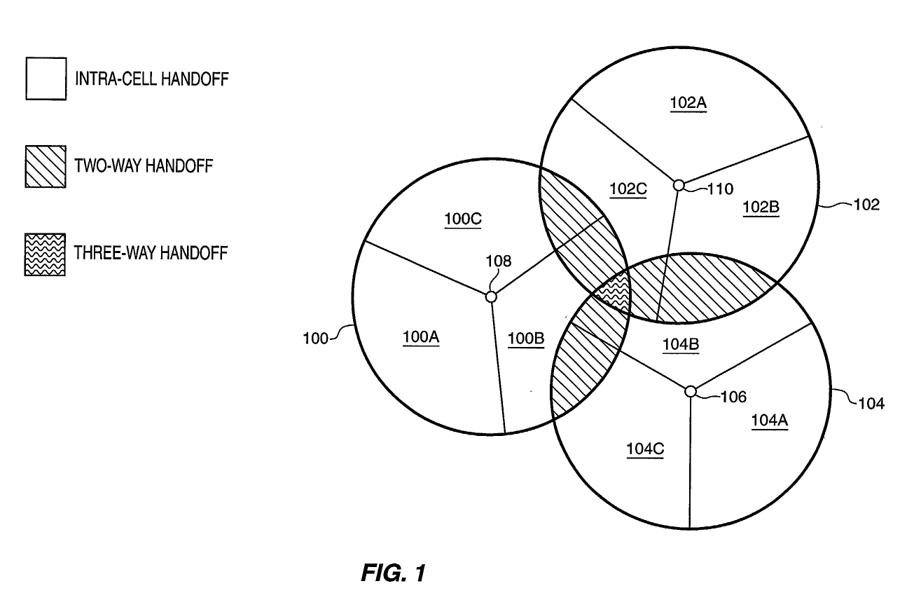

FIG. 1 illustrates an exemplary wireless communication system layout in which the present invention may be embodied. On FIG. 1, three cells 100-104 are shown. The cells 100-104 are further divided into three sectors, such that cell 100 includes cell sectors 100A-C, cell 102 includes cell sectors 102A-C, and cell 104 includes cell sectors 104A-C. Those skilled in the art will appreciate that the communication system of FIG. 1 would include additional cell sectors although only cells 100-104 are shown for purposes of clarity.

FIG. 1 also indicates via the various shadings, areas within the cells 100-104 where a multi-channel soft handoff according to the present invention is likely to occur. Alternatively, however, the present multi-channel soft handoff may occur when a mobile unit is located in any area of a cell as a matter of design choice. The present multi-channel soft handoff could be an intra-cell (within the same cell) handoff between different frequency channels provided by a single base station as indicated by the intra cell handoff zone designated on FIG. 1. The present multi-channel soft handoff could also be an inter-cell (cell to cell) handoff between one or more base stations as indicated by the two-way and three-way handoff zones designated on FIG. 1. In addition, as will become apparent from the following description, the present multi-channel soft handoff may also be an inter/intra-cell soft handoff between one or more base stations.

Each cell 100-104 includes a respective one of three base stations 106-110. The base stations 106-110 could be any base station configured in accordance with the principles of the present invention, namely capable of performing an intra-cell, inter-cell, or inter/intra-cell soft handoff between different frequency channels. The base stations 106-110 include signaling links between them permitting the exchange of messages. The messages may be passed directly between the base stations 106-110 or between the base stations 106-110 and a base station controller (not shown).

For purposes of illustration and not of limitation, the present invention will now be described primarily in conjunction with a CDMA wireless system. It should be expressly understood, however, that the principles of the present invention are applicable to other wireless systems where it is desired to perform a soft handoff between at least two different frequency channels.

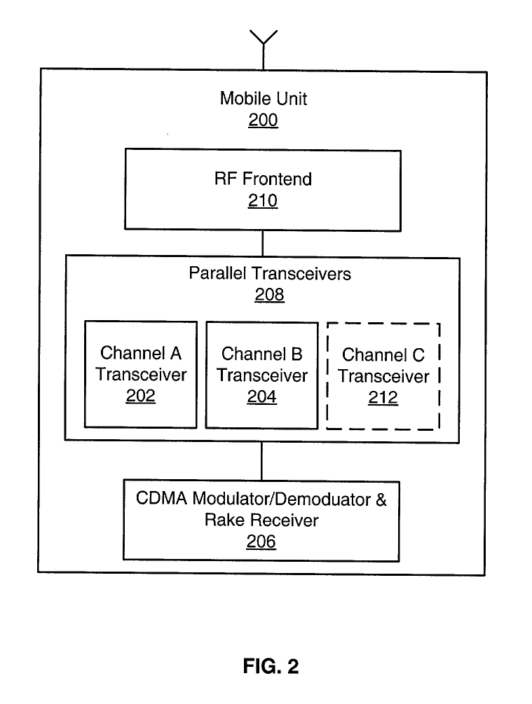

FIG. 2 depicts a mobile unit 200 configured to operate in accordance with the present invention and the wireless communication system of FIG. 1. The mobile unit 200 includes a Radio Frequency (“RF”) front end 210, parallel transceivers 208, and a CDMA modulator/demodulator and rake receiver 206. The parallel transceivers 208 include at least a channel A transceiver 202 and a channel B transceiver 204, although additional parallel channel transceivers, such as the channel C transceiver 212 could be included as a matter of design choice. Alternatively, those skilled in the art will appreciate that a single switched or shared transceiver could be utilized in the place of parallel transceivers 208 so long as the single receiver could efficiently scan the frequency channels.

In a conventional CDMA system, mobile units establish communication with base stations over separate forward/reverse channels each having a bandwidth equal to 1.23 MHz. The base stations may support one or more such channels at different frequencies. As the mobile unit travels within a cell area, the communication service is handed off between the base stations,- with each base station using the same frequency channel for each mobile unit regardless of where the unit is located.

According to the present invention, however, as the mobile unit 200 travels within the cell area defined by cells 100-104, the communication service is handed off, via a soft handoff, between the base stations 106-110 with each base station 106-110 having the option of using the same frequency channel or a different frequency channel. In this regard, the RF front end 210 could be a conventional CDMA front end that conditions the RF CDMA signal exchanged between the mobile unit 200 and the base stations 106-110. The parallel transceivers 208, in turn, process the individual channel frequencies in accordance with conventional CDMA standards to produce the base band channel frequencies. The CDMA modulator portion of 206 decodes and encodes the user channels onto a CDMA channel (typically 1.23 MHz). The rake receiver portion of 206 allows multiple signals to be decoded by the CDMA demodulator.

In a CDMA system, the base stations 106-110 include base station intelligence that continuously provides a pilot signal, (hereinafter referred to simply as a pilot), corresponding to the different sectors and frequency channels available for the respective base station, e.g. base station 108 could provide nine pilots corresponding to three channels (A, B, and C) supported by all three sectors 10A-C in cell 100. The pilots are detectable by the mobile unit 200, and are used to determine when a handoff should be performed. In particular, the mobile unit 200 maintains lists of pilot sets, e.g. an active set, a candidate set, a neighbor set, and a remaining set, according to the strength of an individual pilot.

The active set includes the pilot from the current base station according to the channel the mobile unit 200 is communicating on and the sector the mobile unit 200 is located. To illustrate, when the mobile unit 200 is in cell 100 and communicating on channel A, the active set includes a pilot from base station 108 for channel A. As the mobile unit 200 moves to another cell, e.g. 104, and a handoff is performed, the pilot for channel A is replaced by the new pilot provided by the new base station.

The candidate set, on the other hand, includes the pilots that do not belong to the active set, but which have sufficient strength to indicate that a handoff to the transmitting base station could be performed. Thus, prior to handoff, but while the mobile unit 200 is in an area such as 100B where a two channel soft handoff is possible, the pilots for the potential handoff sectors, e.g. 104B and 104C, may be stored in the candidate set. The neighbor set includes the next likely candidates for a handoff, while the remaining set includes all other possible pilots.

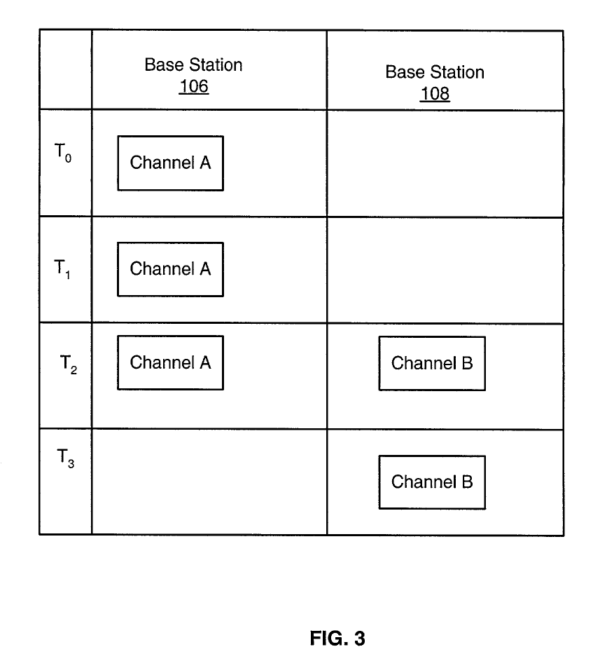

FIG. 3 illustrates a logical representation of a multi-channel two-way inter-cell (cell to cell) soft handoff according to the present invention. Those skilled in the art, however, will appreciate how this example could be combined with other examples disclosed herein to form numerous additional examples in accordance with the principles of the present invention.

While the protocol of FIG. 3 is applicable to a multi-channel inter-cell soft handoff between any two base stations utilizing different frequency channels, the soft handoff protocol of FIG. 3 is described in relation to a handoff between the base station 106 and the base station 108 for purpose of illustration. Additionally, the protocol of FIG. 3 assumes that the base station 106 at least supports a channel A and that the base station 108 at least supports a channel B that is a different frequency channel than channel A. Furthermore, the protocol of FIG. 3 assumes that the mobile unit 200 is initially in sector 104C of cell 104 at time T₀ and thereafter moves into the area indicated as a two-way handoff zone with sector 100B of cell 100.

On FIG. 3, at time T₀, the mobile unit 200 is in CDMA communication with the base station 106 over channel A. The communication over channel A may be established using a conventional setup protocol upon origination of a call by the mobile unit 200. It should also be noted that at time T₀ the pilot for channel A of base station 106 is in the active set and the pilot for channel B of the base station 108 is in the candidate set, although the candidate set would typically include other candidate pilots as well as the pilot for channel B of base station 108.

As the mobile unit 200 enters the two-way handoff zone between sector 104C and sector 100B, at time T1 the pilot for channel A of base station 106 becomes weaker, while the pilot for channel B of base station 108 becomes stronger. Also, at time T₁ the mobile unit 200 provides a message to the base station 106 that indicates pilot strength measurements for the channel A and B pilots of the base stations 106 and 108. The base station 106 compares the pilot strength measurements and determines that the pilot for channel B is sufficiently strong enough to initiate a two-way handoff, and a message indicating the same is provided to the base station 108.

The base station 108 processes the handoff message and allocates channel B to the mobile unit 200. Thereafter, at time T₂, both base station 106 and base station 108 provide a handoff direction message to the mobile unit 200. Responsive to receiving the handoff direction message, the mobile unit 200 transfers the pilot for channel B to the active set and begins simultaneously 110 decoding and combining the call information from channel A and substantially the same call information from channel B using the parallel transceivers 208. At time T₃, the mobile unit 200 provides a handoff complete message to the base station 106 and terminates the communication over channel A with base station 106 to complete the multi-channel inter-cell soft handoff.

It should be noted, that the above described multi-channel inter-cell handoff protocol could be combined with conventional two-way handoff to permit one of the mobile device 200, the base station 106, or the base station 108 to select the channel to be used for communication with the base station 108 according to load capacities. For example, if it is determined that the capacity of channel A on base station 108 is currently taxed, channel B would be selected and the above protocol utilized. If, however, it is determined that the capacity of channel B on the base station 108 is taxed, conventional two-way handoff could be performed on channel A between the base stations 106 and 108.

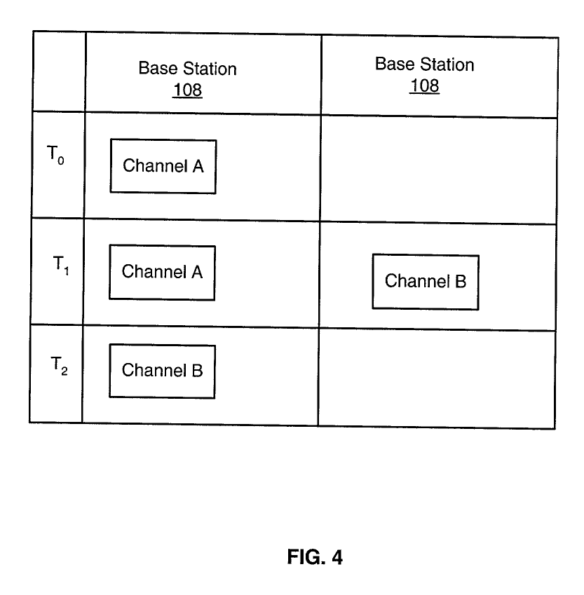

FIG. 4 illustrates an example of a multi-channel intra-cell (within the same cell) soft handoff according to the present invention. Those skilled in the art will appreciate how this example could be combined with the other examples disclosed herein to form numerous additional examples in accordance with the principles of the present invention.

While the protocol of FIG. 4 is applicable to an intra-cell soft handoff between different frequency channels for any one of base stations 106-110, the multi-channel soft handoff protocol of FIG. 4 is described in relation to a handoff between different frequency channels supported by the base station 108. Additionally, the protocol of FIG. 4 assumes that the base station 106 at least supports channels A and B and that channels A and B are different frequency channels. Furthermore, the protocol of FIG. 4 assumes that the mobile unit 200 is initially in sector 100A of cell 100 at time T₀ and thereafter moves into the sector 100C of Cell 100.

On FIG. 4, at time T₀, the mobile unit 200 is in CDMA communication with the base station 108 over channel A. As with the above example, the communication over channel A may be established using a conventional setup protocol upon origination of a call by the mobile unit 200. It should also be noted that at time T₀ the pilot signal for channel A of base station 108 is in the active set and the pilot signal for channel B of the base station 108 is in the candidate set, although the candidate set would typically include other candidate pilots as well as the pilot for channel B of base station 108.

It should be noted that while the base station 108 might be able to continue supporting the CDMA communication with the mobile unit 200 over Channel A, for reasons such as capacity and load balancing it may be desirable to handoff the communication to channel B when the mobile device travels from sector 100A into sector 100C. It will also be appreciated that the handoff to channel B could be performed at any time as a matter of design choice, and thus, is not limited to situations where the mobile unit 200 travels between cell sectors, e.g. 100A and 100C.

At time T₁ the base station 108 determines that the pilot for channel B is sufficiently strong enough to initiate a handoff and allocates channel B to the mobile unit 200. The mobile unit 200 transfers the pilot for channel B to the active set and begins simultaneously decoding and combining the call information from channel A and substantially the same call information from -channel B using the parallel transceivers 208. At time T₂, the mobile unit 200 provides a handoff complete message to the base station 108 and terminates the communication over channel A with base station 108 to complete the multi-channel intra-cell soft handoff.

As with the above example, the intra-cell soft handoff protocol of FIG. 4 could be combined with conventional two-way intra-cell handoff to permit one of the mobile device 200 or the base station 108 to select the channel to be used for communication with the base station 108 according to load capacities. For example, if it is determined that the capacity of channel A on base station 106 is currently taxed, channel B would be selected and the present multi-channel intra-cell soft handoff protocol utilized. If, however, it is determined that the capacity of channel B on the base station 108 is taxed, conventional two-way handoff could be performed on channel A or the present multi-channel intra-cell soft handoff protocol utilized to handoff the call to other supported channels, e.g. a channel C.

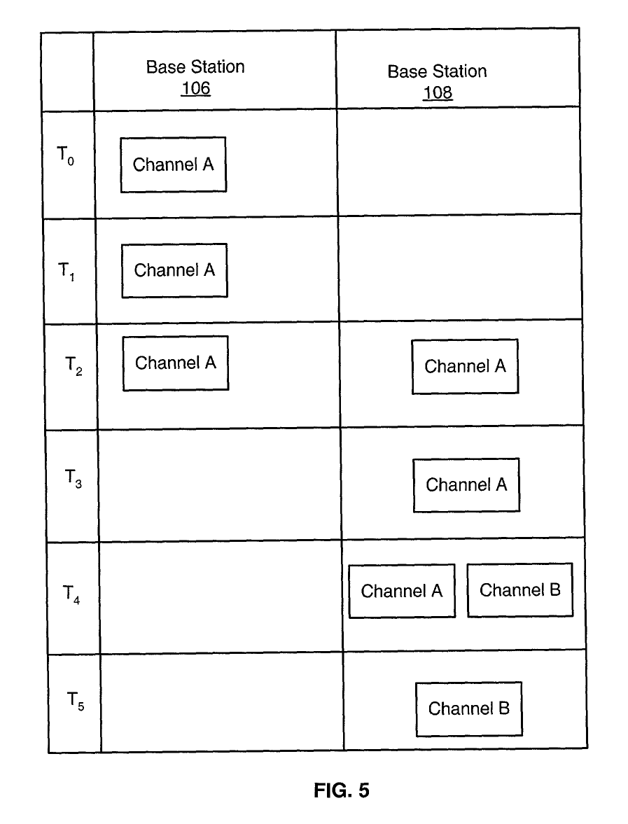

FIG. 5 illustrates another example of a multi-channel inter-cell (cell to cell) soft handoff between two different frequency channels. In this case, however, a combination inter/intra-cell handoff is performed to complete the inter-cell handoff between the two different frequency channels. Those skilled in the art will appreciate how this example could be combined with the other examples disclosed herein to form numerous additional examples in accordance with the principles of the present invention.

While the protocol of FIG. 5 is applicable to a multi-channel inter/intra-cell soft handoff between any two base stations utilizing different frequency channels, the soft handoff protocol of FIG. 5 is again described in relation to a handoff between the base station 106 and the base station 108, for purpose of illustration. Additionally, the protocol of FIG. 5 assumes that the base stations 106 at least supports a channel A and the base station 108 at least supports channel A and a channel B that is a different frequency channel than channel A. Furthermore, the protocol of FIG. 5 assumes that the mobile unit 200 is initially in sector 104C of cell 104 at time T₀ and thereafter moves into the area indicated as a two-way handoff zone with sector 100B of cell 100.

On FIG. 5, at time T₀, the mobile unit 200 is in CDMA communication with the base station 106 over channel A. As with the above example, the CDMA communication over channel A may be established using a conventional call setup protocol upon origination of a call by the mobile unit 200. At time T₀ the pilot for channel A of base station 106 is in the active set and the pilot for channel A of the base station 108 is in the candidate set, although the candidate set could include other candidate pilots as well as the pilot for channel A of base station 108.

As the mobile unit 200 enters the two-way handoff zone between sector 104C and sector 100B at time T₁ the pilot for channel A of base station 106 becomes weaker, while the pilot for channel A of base station 108 becomes stronger. Also, at time T₁ the mobile unit 200 provides a message to the base station 106 that indicates pilot strength measurements for the channel A of the base station 106 and channel A of the base station 108. The base station 106 compares the pilot strength measurements and determines that the pilot for channel A of base station 108 is sufficiently strong to initiate a two-way handoff, and a message indicating the same is provided to the base station 108.

The base station 108 processes the handoff message and allocates channel A to the mobile unit 200. Thereafter, at time T₂, both base station 106 and base station 108 provide a handoff direction message to the mobile unit 200. Responsive to receiving the handoff direction message, the mobile unit 200 transfers the pilot for channel A of base station 108 to the active set and begins simultaneously decoding and combining the call information from channel A of base station 106 and channel A of base station 108. At time T₃ the mobile unit 200 provides a handoff complete message to the base station 106, that terminates the communication over channel A with base station 106 to complete the inter-cell portion of the handoff between base stations 106 and 108.

Thereafter, at time T₄ the base station 108 allocates channel B to the mobile unit 200 and the mobile unit 200 begins simultaneously decoding and combining the call information from channel A and call information from channel B, both provided by the base station 108, using parallel transceivers 208. At time T₅, the mobile unit 200 provides a handoff complete message to the base station 108 that terminates the communication over channel A with base station 108 to complete the multi-channel intra-cell portion of the handoff.

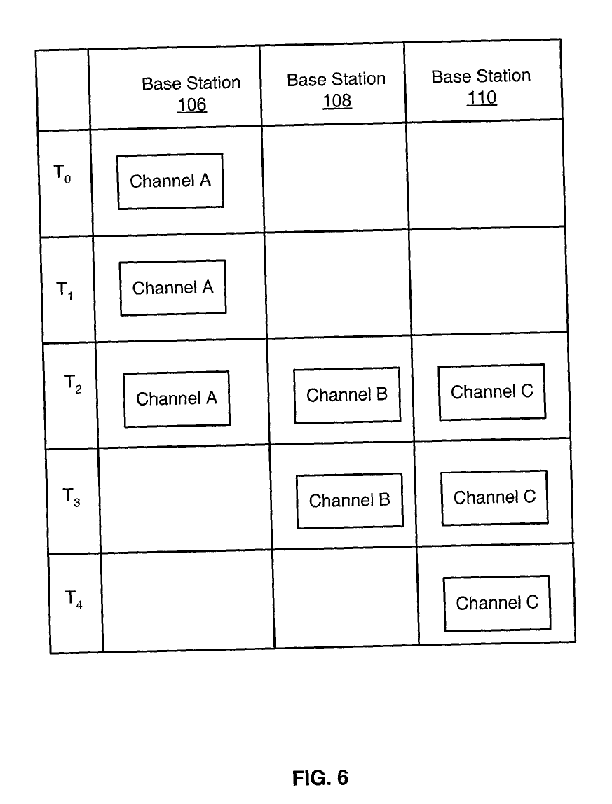

FIG. 6 illustrates an example of a three-way inter-cell (cell to cell) three channel soft handoff according to the present. Those skilled in the art will appreciate how this example could be combined with the other examples disclosed herein to form numerous additional examples in accordance with the principles of the present invention.

The protocol of FIG. 6 assumes that the base station 106 at least supports a channel A, the base stations 108 and 110 at least support channels A, B, and C wherein channels A, B, and C are different frequency channels. Furthermore, the protocol of FIG. 6 assumes that the mobile unit 200 is initially in sector 104B of cell 104 at time T₀ and thereafter moves into the area indicated as a three-way handoff zone with sector 100B of cell 100 and sector 102C of cell 102.

On FIG. 6, at time T₀, the mobile unit 200 is in CDMA communication with the base station 106 over channel A. As with the above example, the CDMA communication over channel A may be established using a conventional setup protocol upon origination of a call by the mobile unit 200. At time T₀ the pilot for channel A of base station 106 is in the active set and the pilots for channels A, B, and C for the base stations 108 and 110 are in the candidate set.

As the mobile unit 200 enters the three-way handoff zone between sectors 104B, 100B and 102C, at time T₁ the pilot for channel A of base station 106 becomes weaker, while the pilots for channels A, B, and C for base stations 108 and 110 become stronger. Also, at time T₁ the mobile unit 200 provides a message to the base station 106 that indicates pilot strength measurements for channel A at the base stations 106 and channels A, B, and C at the base stations 108 and 110. The base station 106 compares the pilot strength measurements and one of the channels A, B, and C on base stations 108 and 110 are selected according to a capacity algorithm.

The capacity algorithm could be logic included in the base station intelligence. For example, the base station 108 may select channel B to handle the call and the base station 110 may select channel C to handle the call according to current capacities on the respective channels for the base stations 108 and 110. It will be appreciated that in this case the parallel transceiver 208 would include the transceiver for channel C, in addition to the transceivers for channels A and B.

Responsive to the selection of the respective channels, in this case channel B for base station 108 and channel C for base station 110, the base station 108 allocates channel B to the mobile unit 200 and the base station 110 allocates channel C to the mobile unit 200. Thereafter, at time T₂, base stations 106-110 provide a handoff direction message to the mobile unit 200. Responsive to receiving the handoff direction message, the mobile unit 200 transfers the pilot for channel B of base station 108 and the pilot for channel C of the base station 110 to the active set and begins simultaneously decoding and combining the call information from base station 106 over channel A, substantially similar call information from base station 108 over channel B, and substantially similar call information from base station 110 over channel C. At time T₃ the mobile unit 200 provides a handoff complete message to the base station 106, that terminates the communication over channel A with base station 106 to complete the multi-channel inter-cell three channel soft handoff between base station 106 and the base stations 108 and 110.

Thereafter, at time T₄ a handoff to one of the base stations, 108 and 110, is completed depending on the movement of the mobile unit 200, e.g. if the mobile unit 200 moves into cell 100 the call is handed off to base station 108 over channel B and if the mobile unit 200 moves into cell 102 the call is handed off to base station 110 over channel C as shown on FIG. 6.

Advantageously, the multi-channel soft handoff protocols of the present invention provide the distinct advantage of permitting a soft handoff between at least two base stations over different frequency channels. This is in contrast to the prior art, requiring utilization of the less reliable hard handoff protocol where a handoff is performed between two different frequency channels.

Yet, another advantage of the present multi-channel soft handoff protocol is that interference between neighboring cells during the handoff procedure is reduced. For instance, during conventional soft handoff between the same frequency channel, interference exists between the call being handed off and other calls within the two cells using the same frequency channel. Thus, a call handed off between two cells will for a short time interfere with other traffic on the same channel in both cells. According to the protocol of the present invention, however, the call being handed off creates less interference with other traffic because the call is handed off from one frequency channel to another frequency channel. Thus, to the extent the handed off call interferes with other calls, it will only interfere with calls on the current channel in the current cell and not calls on the new channel in the new cell.

Yet, another advantage of the present multi-channel soft handoff is the elimination of the need to use pilot beacons to aid in handoffs. Pilot beacons are conventionally used during handoffs, such as between multi-channel CDMA networks, where common frequency channels cannot be used. By providing a method of multi-channel soft handoff between different frequency channels, however, the present method eliminates the necessity for pilot beacons to aid in a handoff between systems where common frequency channels cannot be used.

The above-described elements can be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the invention. The term “processing system” refers to a single processing device or a group of inter-operational processing devices. Some examples of processing systems are integrated circuits and logic circuitry. Those skilled in the art are familiar with instructions, processing systems, and storage media.

Those skilled in the art will appreciate variations of the above-described embodiments that fall within the scope of the invention. As a result, the invention is not limited to the specific examples and illustrations discussed above, but only by the following claims and their equivalents.

What is claimed:

1. A method of performing a multi-channel soft handoff in a wireless communication system, the method comprising:
establishing wireless communication between a mobile unit and a first fixed unit over a first frequency channel;
establishing wireless communication between the mobile unit and a second fixed unit over a second frequency channel such that the mobile unit is simultaneously exchanging substantially equivalent communications with the first fixed unit over the first frequency channel and the second fixed unit over the second frequency channel, wherein the first and second channels are different frequency channels; and
terminating the communication between the mobile unit and the first fixed unit over the first frequency channel.

2. The method of claim 1 comprising:
responsive to establishing the wireless communication over the second frequency channel, establishing wireless communication between the mobile unit and a third fixed unit over a third frequency channel such that the mobile unit is simultaneously exchanging substantially equivalent communications with the first fixed unit over the first frequency channel, the second fixed unit over the second frequency channel, and the third fixed unit over the third frequency channel, wherein then first, second, and third frequency channels are different frequency channels.

3. The method of claim 1 wherein the step of establishing the wireless communication between the mobile unit and the second fixed unit over the second frequency channel comprises:
selecting between at least two different frequency channels; and
establishing the wireless communication between the mobile unit and the second fixed unit over the selected one of the at least two frequency channels, wherein the second frequency channel is the selected one of the at least two frequency channels.

4. The method of claim 1 comprising:
establishing wireless communication between the mobile unit and the second fixed unit over a third frequency channel such that the mobile unit is simultaneously exchanging substantially equivalent communications with the second fixed unit over the second and third frequency channels, wherein the second and third frequency channels are different frequency channels.

5. The method of claim 4 wherein the first, second, and third fixed units are located in first, second, and third wireless communication cells respectively.

6. The method of claim 2 wherein the first, second, and third fixed units are Code Division Multiple Access (“CDMA”) base stations, the first, second, and third communication channels are CDMA frequency channels, and the mobile unit is a CDMA mobile unit.

7. A method of performing a multi-channel soft handoff in a wireless communication system, the method comprising:
establishing wireless communication between a mobile unit and a first fixed unit over a first frequency channel;
establishing wireless communication between the mobile unit and the first fixed unit over a second frequency channel such that the mobile unit is simultaneously exchanging substantially equivalent communications with the first fixed unit over the first and second frequency channels, wherein then first and second frequency channels are different frequency channels; and
terminating the wireless communication between the mobile unit and the first fixed unit over the first frequency channel.

8. The method of claim 7 wherein establishing the wireless communication between the mobile unit and the first fixed unit over the second frequency channel comprises:
selecting between at least two different frequency channels; and
establishing the wireless communication between the mobile unit and the first fixed unit over the selected one of the at least two frequency channels, wherein the second frequency channel is the selected one of the at least two frequency channels.

9. The method of claim 7 comprising:
establishing wireless communication between the mobile unit and a second fixed unit over a third frequency channel such that the mobile unit is simultaneously exchanging substantially equivalent communications with the first fixed unit over the second frequency channel and the second fixed unit over the third frequency channel, wherein the second and third frequency channels are different frequency channels; and
terminating the wireless communication between the mobile unit and the first fixed unit over the second frequency channel.

10. The method of claim 8 wherein the first and second fixed units are located in first and second wireless communication cells respectively.

11. The method of claim 8 wherein the first and second fixed units are Code Division Multiple Access (“CDMA”) base stations, the first, second, and third frequency channels are CDMA frequency channels and the mobile unit is a mobile CDMA unit.

12. A method of performing a multi-channel soft handoff in a wireless communication system, the method comprising:
establishing wireless communication between a mobile unit and a first base station over a first frequency channel;
establishing wireless communication between the mobile unit and a second base station over the first frequency channel such that the mobile unit is simultaneously exchanging substantially equivalent communications with the first and second base stations over the first frequency channel;
terminating the communication between the mobile unit and the first base station over the first frequency channel;
establishing wireless communication between the mobile unit and the second base station over a second frequency channel such that the mobile unit is simultaneously exchanging substantially equivalent communications with the second base station over the first and second frequency channels, wherein then first and second frequency channels are different frequency channels; and
terminating the communication between the mobile unit and the second base station over the first frequency channel.

13. The method of claim 12 wherein the step of establishing the communication between the mobile unit and the second base station over the second frequency channel comprises:
selecting between at least two different frequency channels; and
establishing the wireless communication between the mobile unit and the second base station over the selected one of the at least two frequency channels, wherein the second frequency is the selected one of the at least two frequency channels.

14. The method of claim 13 wherein the first and second base stations are located in first and second communication cells respectively.

15. A wireless communication system comprising:
a mobile unit including a first receiver to communicate over a first frequency channel, a second receiver to communicate over a second frequency channel, and a third receiver to communicate over a third frequency channel wherein the first second and third frequency channels are different frequency channels;
a first base station to establish wireless communication with the mobile unit over the first frequency channel; and
a second base station to establish wireless communication with the mobile unit over the second frequency channel, wherein the mobile unit is simultaneously exchanging substantially equivalent communications with the first and second base stations over the first and second frequency channels.

16. The system of claim 15 wherein the mobile unit is configured to terminate the communication with the first base station over the first frequency channel.

17. The system of claim 15 comprising:
a third base station to establish wireless communication with the mobile unit over the third frequency channel, wherein the mobile unit is simultaneously exchanging substantially equivalent communications with the first, second, and third base stations over the first, second, and third frequency channels.

18. The system of claim 15 wherein the wireless communication system comprises:
a Code Division Multiple Access (“CDMA”) communication system.

19. A wireless communication system comprising:
a mobile unit including a first receiver to communicate over a first frequency channel, a second receiver to communicate over a second frequency channel, and a third receiver to communicate over a third frequency channel wherein the first second and third frequency channels are different frequency channels;
a first base station to establish wireless communication with the mobile unit over the first frequency channel and to establish wireless communication with the mobile unit over a second frequency channel, wherein the mobile unit is simultaneously exchanging substantially equivalent communications with the first base station over the first and second frequency channel.

20. The system of claim 19 wherein the mobile unit is configured to terminate the communication with the first base station over the first frequency channel.

21. The system of claim 20 comprising:
a second base station to establish wireless communication with the mobile unit over a third frequency channel, wherein the mobile unit is simultaneously exchanging substantially equivalent communications with the first and second base stations over the second and third frequency channel.

22. The system of claim 19 wherein the mobile unit is configured to terminate the communication with the first base station over the second frequency channel.

23. The system of claim 19 wherein the wireless communication system comprises:
a Code Division Multiple Access (“CDMA”) communication system.
